(19) United States
(12) Patent Application Publication
(10) Pub. No.: US 2010/0262593 A1
(43) Pub. Date: Oct. 14, 2010

(54) AUTOMATED FILTERED INDEX RECOMMENDATIONS

(75) Inventors: Nicolas Bruno, Bellevue, WA (US); Surajit Chaudhuri, Redmond, WA (US); Vivek R. Narasayya, Redmond, WA (US); Manoj A. Syamala, Issaquah, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/420,077

(22) Filed: Apr. 8, 2009

(51) Int. Cl. G06F 17/30

(52) U.S. Cl. 707/715; 707/E17.084

(57) ABSTRACT

The described implementations relate to filtered index recommendations. In one case a filtered index recommendation (FIR) tool is configured to recommend a final set of filtered indexes to use with a workload. The final set is selected from a first set of candidate filtered indexes and a second set of merged filtered indexes.

### BACKGROUND

Existing database systems support different physical database design structures. For instance, SQL Server 2005™ offered by Microsoft® Corporation supports physical design structures such as indexes (both clustered and non-clustered), materialized views (also known as indexed views) and horizontal partitioning.

Newer server software, such as Microsoft Corporation's SQL Server 2008™ can support a new physical design structure called a filtered index. A filtered index can be thought of as a non-clustered index which is defined on a subset of the rows in a table. This subset can be specified by a filter predicate. Filtered indexes can be suitable for queries which select a small percentage of rows from a table. A well-designed filtered index can improve query performance, reduce index storage costs, and reduce index maintenance costs compared to a full-table index. Filtered indexes are also useful when the filter predicate references columns that contain sparse values or heterogeneous data rows in a table. The present concepts relate to harnessing the potential offered by filtered indexes.

### SUMMARY

The described implementations relate to automated filtered index recommendations. In one case a filtered index recommendation (FIR) tool is configured to recommend a final set of filtered indexes to use with a workload. The final set is selected from a first set of candidate filtered indexes and a second set of merged filtered indexes.

The term “tool(s)” may, for instance, refer to device(s), system(s), computer-readable instructions (e.g., one or more computer-readable media having executable instructions), component(s), module(s), and/or methods as permitted by the context above and throughout the document. In various instances, tools may be implemented as hardware, software, firmware, or combination thereof. The above listed examples are intended to provide a quick reference to aid the reader and are not intended to define the scope of the concepts described herein.

### BRIEF DESCRIPTION OF THE DRAWINGS

The accompanying drawings illustrate implementations of the concepts conveyed in the present application. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the Figure and associated discussion where the reference number is first introduced.

FIG. 1 illustrates an example of a system for accomplishing automated filtered index recommendations in accordance with some implementations of the present concepts.

FIGS. 2-3 show flowcharts for implementing automated filtered index recommendations concepts in accordance with some implementations of the present concepts.

FIG. 4 shows an example of a matrix that can aid in accomplishing automated filtered index recommendations in accordance with some implementations of the present concepts.

FIG. 5 shows a flowchart for implementing automated filtered index recommendations concepts in accordance with some implementations of the present concepts.

### DETAILED DESCRIPTION

### Overview

This patent application relates to automated filtered index recommendations. In one case, filtered index recommendation tools (hereinafter “FIR tools”) can automatically recommend filtered indexes for a given set of queries. FIR tools can be thought of as automated physical database design tools. For instance, given a workload of queries and updates, FIR tools can provide an integrated physical design recommendation consisting of horizontal partitioning, indexes, and materialized views. Further, the concepts described in this patent application can allow FIR tools to recommend filtered indexes in addition to the above physical design structures.

In summary, database structures or physical design structures, such as indexes and filtered indexes have an associated cost or overhead. The associated cost can relate, for example, to storage and/or maintenance. FIR tools can receive a workload and output a recommendation of database structures (including standard and/or filtered indexes) to use with the workload. The FIR tools can consider the associated costs in making the recommendation. For instance, one consideration is that too many database structures can result in too much cost or overhead, while too few database structures can produce slow query response performance.

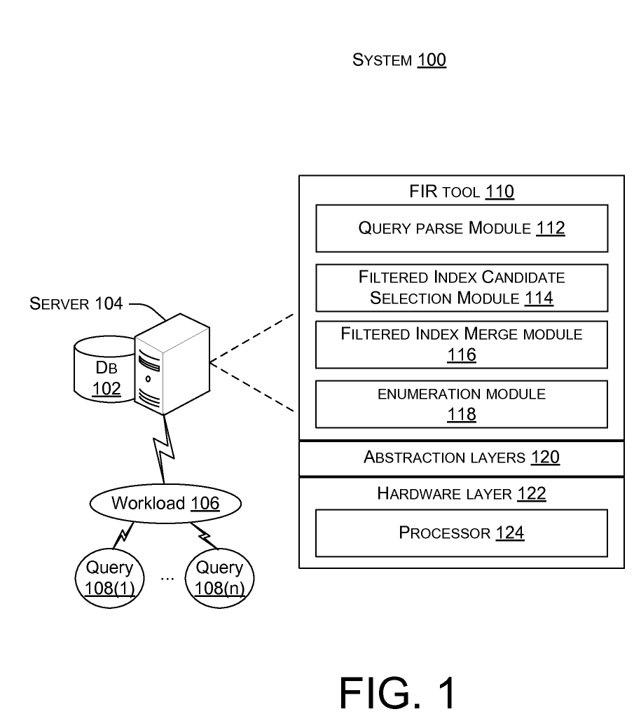

FIG. 1 offers an introductory example of some of the present automated filtered index recommendation concepts in the form of a system 100. For explanation purposes, system 100 includes a database 102 associated with a server 104. A workload 106 of the database 102 can be thought of as a set of all queries 108(1)-108(n) that can be directed to the database 102.

In the case of system 100, server 104 includes a FIR tool 110. The FIR tool can include a query parse module 112, a filtered index candidate selection module 114, a filtered index merge module 116, and an enumeration module 118. FIR tool 110 can operate upon various abstraction layers 120 and a hardware layer 122 that includes a processor 124. The abstraction layers, hardware layer, and processor are illustrated to orient the reader and are not discussed further herein as the functionality should be recognized by the skilled artisan. Further, the above described components may reside on a single machine or be distributed among several networked machines.

Query parse module 112 can function to parse and analyze workload 106. For instance, for an individual query 108(1) from the workload, the query parse module can determine a table of database columns that are referenced by the query. The query parse module can analyze the columns to provide useful information for the filtered index candidate selection module 114.

Filtered index candidate selection module 114 can function to select filtered index candidates relative to database 102. On a query by query basis, the filtered index candidate selection module can evaluate the table and/or columns provided by the query parse module and identify filter predicates that can operate on the columns. The filtered index candidate selection module can generate a first set of filtered index candidates based upon the predicates. These filtered index candidates can be thought of as filtered indexes that are appropriate (and potentially even optimum) for a specific query (such as 108(1)) to the database 102. In some implementations, the filtered index candidate selection module and/or another component can also generate standard (i.e., non-filtered) indexes that may be utilized with the workload.

To summarize, filtered index candidate selection module 114 can evaluate the workload on a query-by-query basis. The filtered index candidate selection module can identify one or more filtered indexes (i.e., winners) per query that satisfy some type of performance metric. For instance, the filtered index candidate selection module can identify the best filtered index for an individual query, or the top two filtered indexes for the query, or two filtered indexes that are good indexes when measured against some performance metric, etc. The filtered index candidate selection module adds these winners to the first set of filtered indexes for the workload. Other potential candidate filtered indexes are pruned or filtered since they are not added to the first set. Thus, processing resources can be conserved by reducing the number of filtered indexes that receive further evaluation.

Filtered index merge module 116 can function to merge filtered index candidates of the first set. The merge operation can produce a second set of filtered indexes. Viewed from one perspective, the second set of filtered indexes may be relatively less performant for specific queries than the candidate filtered indexes of the first set, but tend to be relatively more performant for the workload as a whole when overhead is considered.

Filtered index merge module 116 can recognize instances of similar or overlapping queries. For instance, consider a scenario that involves two queries that relate to a database entry for age. Assume for discussion purposes that the first query relates to age less than 40 and that the second query relates to age less than 45. The filtered index candidate selection module 114 may generate a first filtered index that searches the database's age column with a predicate where the age is less than 40, and a second filtered index that searches the database's age column with a predicate where the age is less than 45. The filtered index merge module 116 can recognize that the second filtered index does an acceptable job for both queries (i.e., age <40 and age <45) with a reduced cost when compared to creating and maintaining both the first and second filtered indexes. Thus, the filtered index merge module can generate the second filtered index to satisfy both queries. The second filtered index is then added to a second set of candidate merged filtered indexes. While the above example relates to two queries, the filtered index merge functionality can be applied to any number of queries.

In the above example, the filtered index generated by the filtered index merge module 116 exactly matches one of the filtered indexes generated by the filtered index candidate selection module 114, but such need not be the case. For example, consider three age related queries. First, where age equals 45-50, second where age is less than 40 and third where age is less than 35. The filtered index candidate selection module might generate a first filtered index where the age equals 45-50, a second where age is less than 40 and a third where age is less than 35. In contrast, the filtered index merge module can generate a single filtered index to satisfy all three queries with a predicate where the age is less than or equal to 50. It is worth noting that in this particular example, the filtered index merge module selects a filtered index that includes values (i.e., ages 40-44) which are not utilized in any of the first through third filtered indexes. Yet the selected filtered index can be an appropriate filtered index for balancing performance and overhead for the three age-related queries. In summary, the filtered index merge module can generate the second set of filtered indexes, such that members of the set satisfy a cost-benefit analysis based upon performance and overhead.

Enumeration module 118 can evaluate the first and second sets of candidate filtered indexes generated by the filtered index candidate selection module 114 and the filtered index merge module 116. The enumeration module can select a third set of filtered indexes that is drawn from the first and second sets. The enumeration module accomplishes the selection of the third set based by considering various constraints, such as total available storage, etc.

In summary, FIR tool 110 can produce a number of recommended filtered indexes which is less than a number of potential filtered indexes, yet the recommended filtered indexes can provide satisfactory system performance. Thus, the recommended filtered indexes can be advantageous in resource constrained scenarios and/or for reducing maintenance costs compared to maintaining a greater number of candidate filtered indexes.

In a specific implementation, FIR tool 110 is manifest as a database engine tuning advisor (DTA) offered relative to SQL Server 2008™ offered by Microsoft Corporation. Other FIR tools can be implemented in other database environments, such as Oracle brand offerings or IBM brand offerings, among others.

### METHOD EXAMPLES

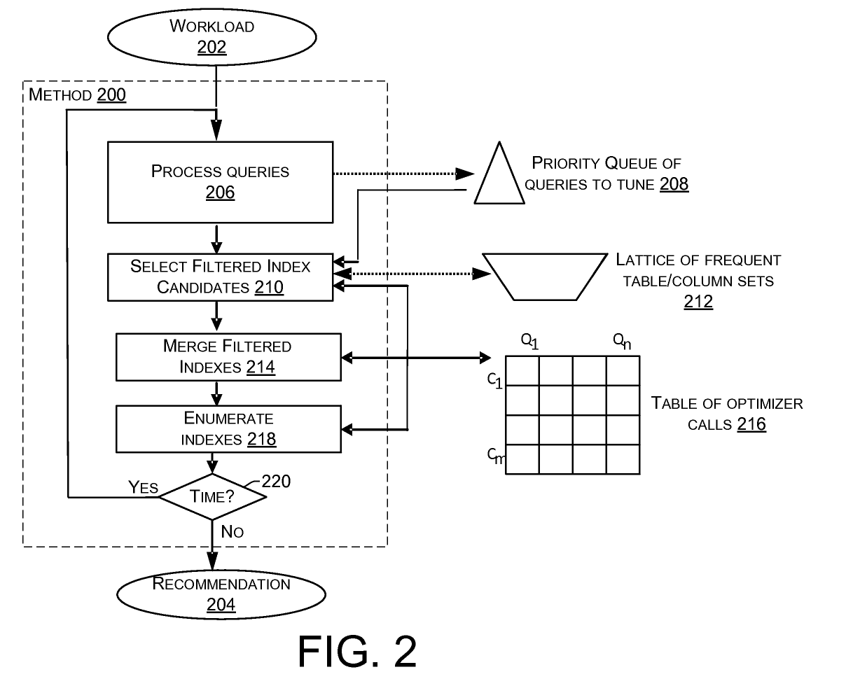

FIG. 2 shows a flowchart of a filtered index recommendation method or technique 200 that is consistent with at least some implementations of the present concepts. The order in which the method 200 is described is not intended to be construed as a limitation, and any number of the described blocks can be combined in any order to implement the method, or an alternate method. Furthermore, the method can be implemented in any suitable hardware, software, firmware, or combination thereof, such that a computing device can implement the method. In one case, the method is stored on a computer-readable storage media as a set of instructions such that execution by a computing device causes the computing device to perform the method.

Method 200 starts with a workload 202 as input and finishes by outputting a filtered index recommendation for the workload at 204. In some cases, the method may also receive a set of constraints associated with processing the workload. For instance, one constraint can relate to a time period for processing the workload.

At block 206, the method processes queries of the workload. In one case, this processing can entail parsing and compressing the queries. The processing can generate a priority queue of queries at 208.

At block 210, the method selects filtered index candidates. In this case, block 210 is performed on the priority queue of queries 208. Performance of block 210 can generate a lattice of frequent table/column sets 212. A relatively detailed example for accomplishing block 210 is described below in relation to FIG. 3.

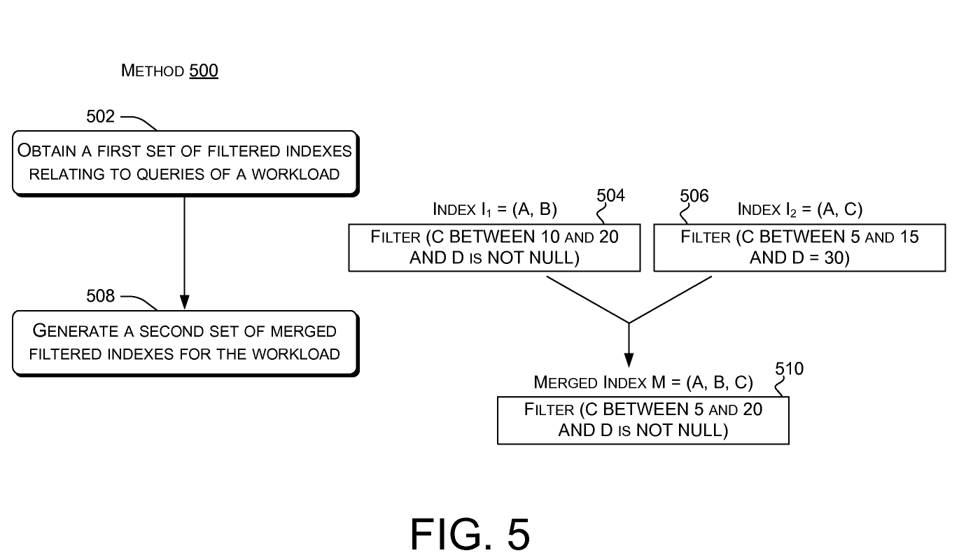

At block 214, the method merges filtered indexes. The merge operation can generate a table of optimizer calls at 216. A relatively detailed example for accomplishing block 214 is described below in relation to FIG. 5.

At block 218, the method enumerates indexes from block 210 and block 214. Viewed one way, block 218 can be thought of as performing a cost benefit analysis on the candidate filtered indexes obtained from block 210 and 214 to produce a recommended set of filtered indexes for the workload. In some cases, the enumeration of block 218 can include a combination of filtered indexes selected from the first and/or second sets and/or standard (i.e., non-filtered indexes). In one case, the cost benefit analysis may relate to a storage limit available for the filtered indexes. In such a case, the enumeration can recommend filtered indexes that are performant for the workload and which occupy an amount of storage that is less than or equal to the available limit.

As mentioned above, the workload may be associated with a time constraint that defines how long processing should be performed to generate appropriate recommendations for the workload. If processing time remains at 220 then the method returns to block 206. If no time remains, (i.e., no at 220) then the method outputs the recommendation 204. In summary, this block can force the recommendations to be generated consistent with the constraints rather than continuing indefinitely. Accordingly, the method allows constraints to be placed on how many resources to utilize in order to generate the recommendations.

### CANDIDATE SELECTION METHOD EXAMPLE

FIG. 3 shows a flowchart of a filtered index candidate selection method or technique 300 that is consistent with at least some implementations of the present concepts.

At block 302, the method obtains a query(s) of a workload. As mentioned above in relation to FIG. 2, preprocessing may be performed on the query to generate a listing or table with columns of indexes.

At block 304, the method identifies at least one filtered index for the query that satisfies a performance metric. In some cases, the identifying can include evaluating the table and columns and identifying filtered predicates that can operate on the indexed columns. The method can generate one or more filtered index candidates based upon the columns and associated predicates. These filtered index candidates can be thought of as filtered indexes that are appropriate (and potentially even optimum) for the query.

A multitude of different performance metrics can be utilized with method 300. In one case, the performance metric relates to data accessed by the filtered index compared to other filtered indexes and/or standard indexes. For instance, assume that a column has 100 rows of data that would be accessed using a standard index. If the filtered index accessed most of the rows, say 90 rows, then the filtered index may not satisfy the performance metric. In contrast, if the filtered index eliminates 70 rows from consideration, then the filtered index may satisfy the performance metric. These values are offered only for explanation purposes and are not intended to be limiting in any way.

The method can be repeated on a query-by-query basis until all queries of the workload have been evaluated. The method can add the filtered index candidates that satisfy the performance metric to the first set, while pruning the remaining filtered indexes. In some cases, multiple potential candidate filtered indexes can be identified for the query. The potential candidate filtered indexes can be ranked against one another. Higher ranking potential filtered indexes can be treated as candidates and added to the first set, while lower ranking indexes are pruned.

Viewed from one perspective, block 304 can separate syntactically relevant filtered indexes from non-syntactically relevant filtered indexes. The syntactically relevant filtered indexes can be added to the first set, while the others are pruned. Filtered indexes can be thought of as being syntactically relevant where the predicate or filter meaningfully reduces a number of rows that are searched in an indexed column while producing satisfactory search results.

Algorithm 1 offers a specific detailed example of an implementation that can accomplish method 300.

Algorithm 1

```
Input: Query Q
Output: Set S of syntactically relevant filtered indexes for
Q.
  1.  For each table T in Q
  2.  For each syntactically relevant index I on T
  3.  Let I_{f} = I // I_{f} is a new filtered index
  4.  For each column C in I_{f}
  5.  Begin
  6.  For each predicate p on T
  7.  If p references column C AND the fraction of
      NULLs in C exceeds threshold t
  8.  Add predicate ‘C IS NOT NULL’ to I_{f}
  9.  Else
  10.  Add predicate p to I_{f} only if the
      predicate cannot be answered by an index seek of I
  11.  End
  12.  S = S ∪ I_{f}
  13.  Return S
```

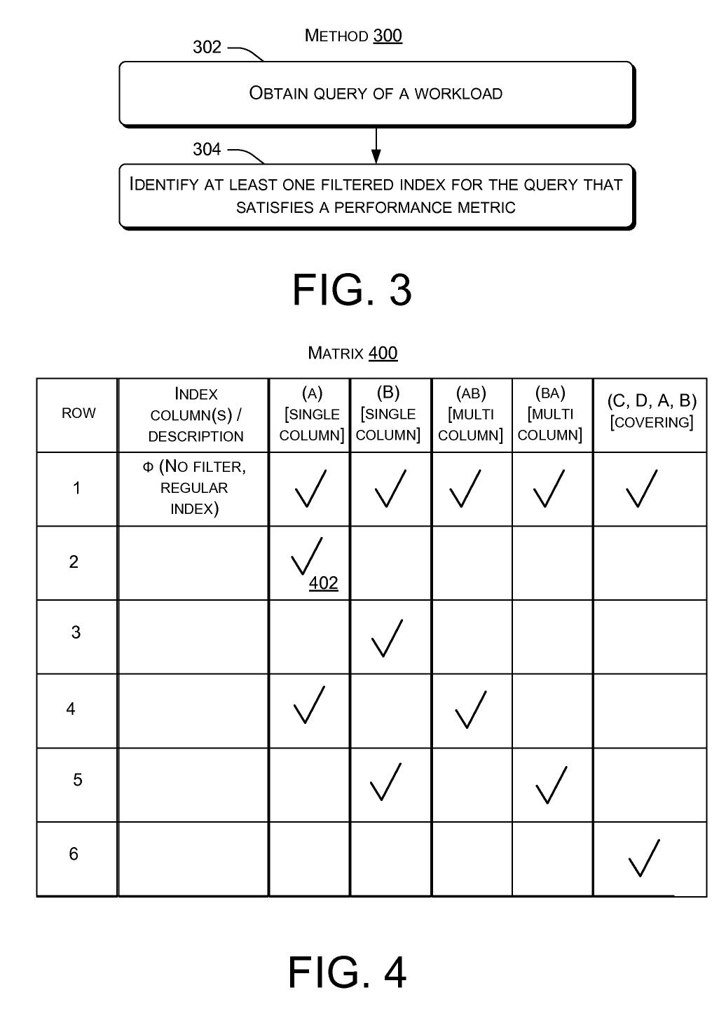

FIG. 4 provides a matrix 400 of potential indexes that can be useful in understanding the functionality offered by the method of FIG. 3. In this case, the method selects from columns A, B, C, and D from table T where A<10 and B=20.

A vertical column in the above matrix shows the sequence of columns on which the index is defined. A horizontal row in the above matrix defines the filter (if any) used in the index. The first row (i.e., row 1) in the above matrix corresponds to (regular) indexes that an existing tool might consider for query Q during the candidate selection step, i.e. indexes having no filter. The cells in Rows 2-6 of the matrix show the filtered indexes that FIR tools can consider.

One motivation for filtered indexes is to complement sparse column functionality. The rows corresponding to the “IS NOT NULL” predicates (Rows 2, 3) are designed to exploit this feature. If column A contains a significant fraction of NULL (i.e., missing) values then it is useful to have a filtered index with a predicate such as “A IS NOT NULL” as indicated at 402. To determine if a column has a significant fraction of NULL values, the FIR tool can consult a histogram on column A that is available from the database system catalogs. If the fraction of NULL values in the column exceeds a pre-defined threshold t (e.g. t=0.25), the FIR tool can consider a filtered index of the form I (A) Filter (A IS NOT NULL) which indexes only the non-NULL values of A. This can lead to a smaller, more efficient index, with lower index maintenance costs when compared to a non-clustered index on the entire column A. Such filtered indexes are generated in Step 8 of the above algorithm 1.

The following discussion continues the above example in an attempt to clarify step 10 of algorithm 1. This step generates filtered indexes that exploit data filtering for selection predicates that occur in the query (not related to sparseness). Consider the filtered indexes corresponding to Row 4 (i.e., the row corresponding to the predicate (A<10) in the matrix):

(1)I(A) Filter (A<10)

(2)I(B) Filter (A<10).

Both of these indexes are useful in answering the query, however index (1) gives little or no additional benefit relative to the original index I(A), since I(A) is already effective in filtering the rows for which (A<10) is true. Hence, the discussion does not consider index (1). Similarly, the discussion considers an index I (B, A) Filter (A<10) but not index I (A, B) Filter (A<10). In general, it can be observed that a filtered predicate on a column C is redundant, if the index has C as a leading column.

For one perspective, the rightmost cell in Row 6 in matrix 400 defines the potentially “best” filtered index for the query since: (1) it contains all the relevant predicates in the query thereby consisting of the minimal number of rows in the table needed to answer the query; (2) it is a minimal covering index since it contains exactly the columns needed to answer the query.

### FILTERED INDEX MERGE METHOD EXAMPLE

FIG. 5 shows a method 500 that relates to merging filtered indexes. At block 502, the method obtains a first set of filtered indexes relating to queries of a workload. For discussion purposes, consider that the first set includes filtered index I₁ (identified at 504) and filtered index I₂ (identified at 506).

At block 508, the method generates a second set of merged filtered indexes for the workload. For discussion purposes, consider merged filtered index M (identified at 510) as the second set. Note that filtered index I₁ is indexed on two columns (A, B). Filtered index I₂ is indexed on columns (A, C). The merged index M includes the columns of both I₁ and I₂ in that M indexes on columns (A, B, C). Further, the filters of index M capture the filters of both indexes both I₁ and I₂. For instance, in index I₁ the filter C has a value between 10 and 20, and in index I₂ C has a value between 5 and 15. In index M the value for filter C is between 5 and 20 which subsumes the values of C in both I₁ and I₂. Similarly, relative to filter D, the value for index I₁ is not null and for the value for index I₂ is 30. In index M the value for filter D is not null which subsumes both of the other indexes.

To summarize, candidate selection methods can generate filtered indexes that are performant (and potentially optimal) for a specific query in the workload. One goal of block 508 is to introduce additional candidates that may be sub-optimal for any particular query in the workload, but may be performant (and potentially optimal) for the workload as a whole. Such indexes are especially valuable when there are overhead constraints. For instance, merged filtered indexes can be advantageous where there is a limited storage budget for the physical design structures or there are updates in the workload that increase the cost of maintaining the physical design structures in an up to date status.

This section offers a more detailed description of one implementation of merging filtered indexes. This method takes as input a set of filtered indexes and regular indexes and produces a set of merged indexes as output. The index merging process for filtered indexes can utilize a sequence of pair-wise merging of the candidate indexes to produce the output merged index. One potential challenge for filtered indexes is to define how a given pair of indexes is merged.

This particular index merging method maintains the property that for any query that uses the columns in the set of candidate indexes (I₁, I₂); the resulting merged index also contains the columns utilized to answer the query. Note that at least in some configurations, the candidate indexes that are merged should satisfy the property that they are on the same table.

In this case, the merge routine can be applied to merging index pairs where both indexes are filtered indexes; where one index is a filtered index and the other is a standard non-filtered index, and where both indexes are standard indexes. In some instances, the method tries to maintain the index seek benefit of the indexes being merged by merging the indexes in a particular order. The discussion below describes how to determine the filter of the merged index. This algorithm extends the view merging technique for selection views for the case of IS NOT NULL predicates. This method models a filtered index similar to a single-table selection view for the purposes of merging the filters. The algorithm below relates to the cases of: (1) range predicates of the form (column BETWEEN low AND high), where low and high are the low and high end of the range respectively; (2) predicates of the form column IS NOT NULL.

Algorithm 2.

```
Input: Indexes I₁ and I₂
Output: Merged index M
  1. Columns of M = <Columns of I₁, (distinct) columns of
    I₂>
  2. For each column that occurs in a predicate in both I₁
    and I₂
  3.  Let p₁ be the predicate in I₁ and p₂ be the predicate
    in I₂
  4.  If either p1 or p2 or both are of the form column IS
    NOT NULL
  5.  pₘ = column IS NOT NULL
  6.  Else // both are range predicates
  7.  low = min(p₁.low, p₂.low)
  8.  high = max(p₁.high, p₂.high)
  9.  pₘ = column BETWEEN low AND high
  10.  End If
  11.  Add predicate pₘ to M
  12.  Return M
```

In summary, FIR tools can offer an automated physical database design tool. Given a workload of queries and updates, FIR tools can provide an integrated physical design recommendation consisting of horizontal partitioning, indexes, and materialized views. This patent application describes new techniques so that FIR tools can recommend filtered indexes in addition to, or alternatively to, physical design structures.

### CONCLUSION

Although techniques, methods, devices, systems, etc., pertaining to automated filtered index recommendations are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A system, comprising:
a filtered index recommendation (FIR) tool configured to recommend a final set of filtered indexes to use with a workload, wherein the final set is selected from a first set of candidate filtered indexes and a second set of merged filtered indexes.

2. The system of claim 1, wherein the FIR tool is configured to consider sparseness as a factor in recommending individual filtered indexes.

3. The system of claim 1, wherein the FIR tool is further configured to consider other available database structures in addition to filtered indexes for recommendation for the workload.

4. The system of claim 1, wherein the FIR tool comprises a filtered index candidate selection module configured to generate the first set of candidate filtered indexes.

5. The system of claim 1, wherein the FIR tool comprises a filtered index merge module configured to generate the second set of candidate filtered indexes from the first set of candidate filtered indexes.

6. The system of claim 1, wherein the FIR tool is configured to recommend the final set of filtered indexes that occupy less than a predetermined amount of storage.

7. A computer-readable storage media having instructions stored thereon that when executed by a computing device cause the computing device to perform acts, comprising:
obtaining a query of a workload; and,
identifying at least one filtered index for the query that satisfies a performance metric.

8. The computer-readable storage media of claim 7, wherein the obtaining comprises obtaining a table of database columns that are referenced by the query.

9. The computer-readable storage media of claim 8, further comprising evaluating sparseness of individual columns.

10. The computer-readable storage media of claim 8, wherein the identifying comprises identifying filter predicates that can operate on the database columns and utilizing the filter predicates to generate the at least one filtered index.

11. The computer-readable storage media of claim 7, wherein the obtaining and identifying are repeated for each query of the workload.

12. The computer-readable storage media of claim 7, wherein the identifying comprises identifying multiple filtered indexes for the query and further comprising ranking the multiple filtered indexes.

13. The computer-readable storage media of claim 12, further comprising adding a highest ranking filtered index to a set of candidate filtered indexes for the workload.

14. The computer-readable storage media of claim 7, wherein the performance metric relates to a relative reduction in a percentage of rows in a column that are accessed with the at least one filtered index compared to a non-filtered index.

15. A method, comprising:
obtaining a first set of filtered indexes relating to queries of a workload; and,
generating a second set of merged filtered indexes for the workload.

16. The method of claim 15, wherein the generating comprises merging a pair of filtered indexes from the first set to produce a merged filtered index.

17. The method of claim 15, wherein the generating comprises merging a pair of filtered indexes from the first set to produce a merged filtered index and wherein the merged filtered index includes columns that are used to satisfy a query in the pair of filtered indexes.

18. The method of claim 15, wherein the generating comprises merging a pair of filtered indexes from the first set to produce a merged filtered index and wherein the merged filtered index includes a predicate that subsumes the predicates of the pair of filtered indexes.

19. The method of claim 15, wherein the generating comprises merging a pair of filtered indexes from the first set to produce a merged filtered index that searches all columns included in the pair of filtered indexes.

20. The method of claim 15, wherein the generating considers an amount of storage available for the filtered indexes.
